(19) United States
(12) Patent Application Publication
(10) Pub. No.: US 2026/0194261 A1
(43) Pub. Date: Jul. 9, 2026

(54) WATER HEATER APPLIANCE CONTROL LOCK IN RECREATIONAL VEHICLES

(71) Applicant: Haier US Appliance Solutions, Inc., Wilmington, DE (US)

(72) Inventors: Andrew Scott Hapner, Findlay, OH (US); Richard Dustin Henderson, La Grange, KY (US); William Troyer, South Bend, IN (US)

(21) Appl. No.: 19/014,339

(22) Filed: Jan. 9, 2025

(51) Int. Cl. F24H 15/281; B60P 3/36; F24H 1/00; F24H 15/172

(52) U.S. Cl. CPC F24H 15/281; B60P 3/36; F24H 1/009; F24H 15/172

(57) ABSTRACT

A water heater appliance includes a cabinet, a heat exchanger positioned within the cabinet, a controller positioned within the cabinet, and a control panel in signal communication with the controller. The control panel includes a plurality of user input devices. A method of operating the water heater appliance includes the controller detecting a first multi-input event at the control panel and disabling the plurality of user input devices of the control panel in response to detecting the first multi-input event.

### FIELD OF THE INVENTION

The present subject matter relates generally to recreational vehicle water heaters, and more particularly to control systems thereof.

### BACKGROUND OF THE INVENTION

Water heaters for use with recreational vehicles (RV) typically include a water tank in combination with an internal heating element. Most internal heating elements in water heaters used in recreational vehicles are dual fuel: liquid petroleum gas and electric heating. The water heater is mounted on the recreational vehicle in a convenient position connected to cold water supply and hot water outlet pipes, respectively receiving cold water from a suitable water supply source and for directing heated water for use in cooking, bathing, and the like.

Typical water heaters include an interface where users may adjust the temperature of the water heated by the water heater appliance. However, issues may arise when the temperature of the water heater appliance is adjusted during use, such as when a user is showering. Accordingly, a water heater appliance configured to lock the controls would be desirable. Further, a recreational vehicle with a water heater appliance configured to selectively lock the controls would be advantageous.

### BRIEF DESCRIPTION OF THE INVENTION

Aspects and advantages of the invention will be set forth in part in the following description, or may be apparent from the description, or may be learned through practice of the invention.

In one example embodiment, a water heater appliance for a recreational vehicle is provided. The water heater appliance defines a vertical direction, a lateral direction, and a transverse direction. The vertical, lateral, and transverse directions are mutually perpendicular. The water heater appliance includes a cabinet, and a heat exchanger positioned within the cabinet. A combustion chamber is positioned within the cabinet. The combustion chamber includes a burner assembly. The combustion chamber is in thermal communication with the heat exchanger. The water heater appliance also includes a controller positioned within the cabinet, and a control panel in signal communication with the controller. The control panel includes a plurality of user input devices. The controller is configured to detect a first multi-input event at the control panel and disable the plurality of user input devices of the control panel in response to the first multi-input event.

In another example embodiment, a method of operating a water heater appliance for a recreational vehicle is provided. The water heater appliance includes a cabinet, a heat exchanger positioned within the cabinet, a controller positioned within the cabinet, and a control panel in signal communication with the controller. The control panel includes a plurality of user input devices. The method includes the controller detecting a first multi-input event at the control panel and disabling the plurality of user input devices of the control panel in response to detecting the first multi-input event.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an example embodiment of a water heater appliance for a recreational vehicle, according to aspects of the present subject matter.

FIG. 2 provides a perspective view of the water heater appliance of FIG. 1, with a door of the water heater appliance removed, according to aspects of the present subject matter.

FIG. 3 provides a perspective, sectional view of the water heater appliance of FIG. 1, according to aspects of the present subject matter.

FIG. 4 provides a schematic of the water heater appliance of FIG. 1 in communication with a control panel, according to aspects of the present subject matter.

FIG. 5 provides a front view of the example control panel of FIG. 4, according to aspects of the present subject matter

FIG. 6 provides a front view of the example control panel of FIG. 4 during a multi-input event, according to aspects of the present subject matter.

FIG. 7 provides a flow chart illustrating an example method of operating a water heater appliance, according to aspects of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified.

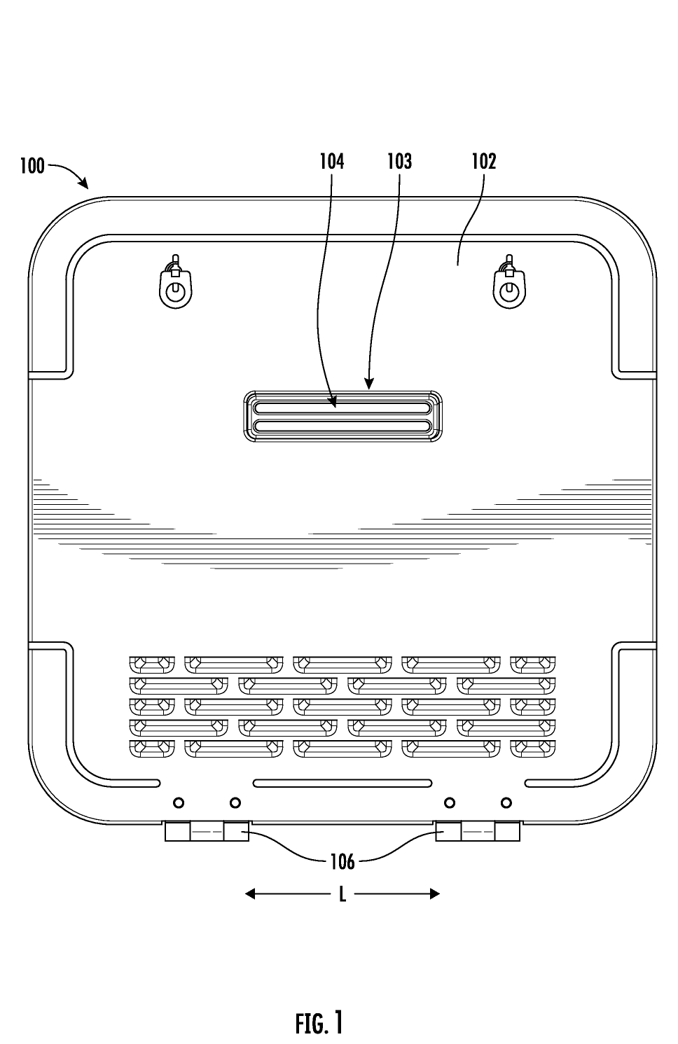

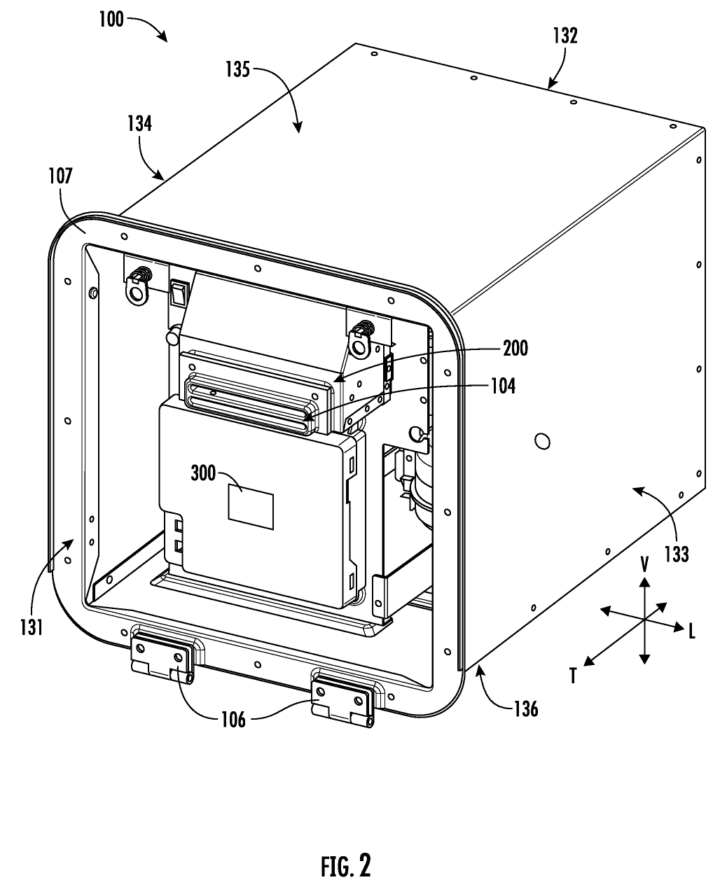

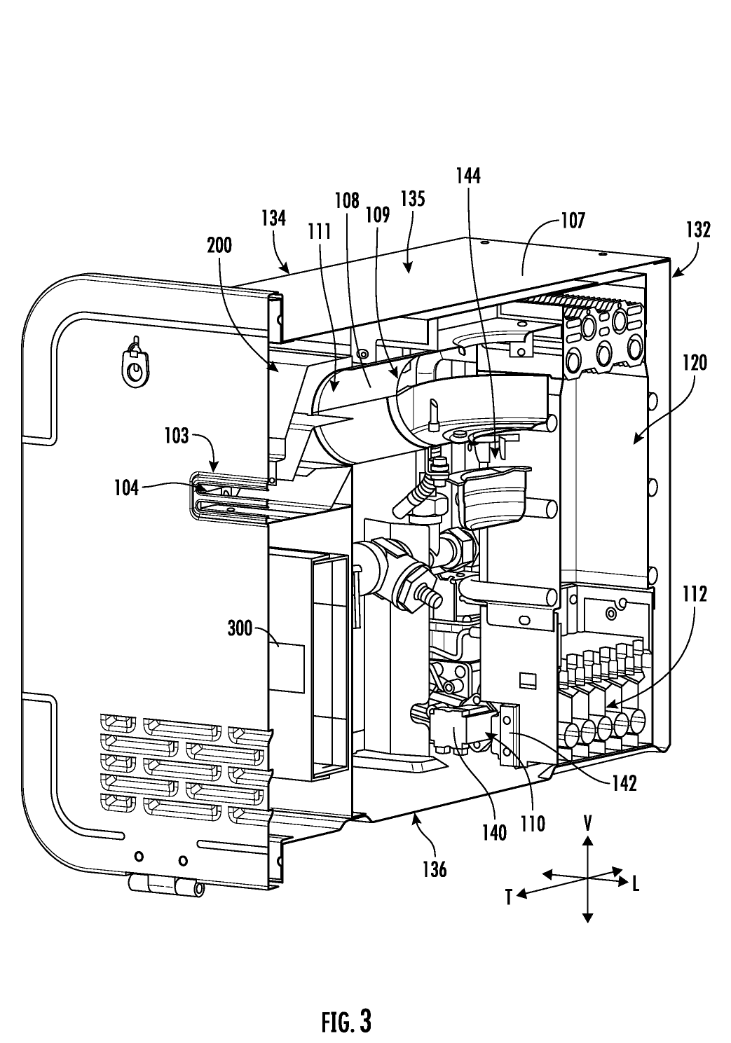

Referring now to FIGS. 1 through 3, an example tankless water heater appliance will be described in accordance with example aspects of the present subject matter. Specifically, FIG. 1 provides a front view of an example water heater appliance 100, FIG. 2 provides a perspective view of water heater appliance 100, and FIG. 3 provides a perspective, cross-sectional view of water heater appliance 100. As illustrated, water heater appliance 100 generally defines a vertical direction V, a lateral direction L, and a transverse direction T, each of which is mutually perpendicular, such that an orthogonal coordinate system is generally defined.

According to example embodiments, water heater appliance 100 may include a cabinet 107 that is generally configured for containing and/or supporting various components of water heater appliance 100 and which may also define one or more internal chambers or compartments of water heater appliance 100. In this regard, as used herein, the terms “cabinet,” “housing,” and the like are generally intended to refer to an outer frame or support structure for appliance 100, e.g., including any suitable number, type, and configuration of support structures formed from any suitable materials, such as a system of elongated support members, a plurality of interconnected panels, or some combination thereof. It should be appreciated that cabinet 107 does not necessarily require an enclosure and may simply include an open structure supporting various elements of appliance 100. By contrast, cabinet 107 may enclose some or all portions of the interior of cabinet 107. It should be appreciated that cabinet 107 may have any suitable size, shape, and configuration while remaining within the scope of the present subject matter.

In general, cabinet 107 may extend in the transverse direction T between a front side 131 and a back side 132, in the vertical direction V between a top side 135 and a bottom side 136, and in the lateral direction L between a first side 133 and a second side 134. In general, water heater appliance 100 may include a panel, e.g., a door 102, coupled to cabinet 107, as shown in FIG. 1 in a closed position, and removed in FIG. 2 for clarity in showing within cabinet 107. In general, door 102 may be mounted to cabinet 107 via hinges 106, e.g., hinges 106 may rotatably couple door 102 to cabinet 107. Opening door 102 about hinge 106 may permit selective access to internal components within cabinet 107, such as a burner assembly 110, a heat exchanger 120 and/or, an exhaust box 200, each of which are described in greater detail below. In general, door 102 of water heater appliance 100 may include a slot, such as an exhaust port 103, for an exhaust outlet 104, as will be described in greater detail below.

In the present example embodiment, water heater appliance 100 may include a heat exchanger 120 positioned within cabinet 107. Heat exchanger 120 may generally provide heat to water flowing through water heater appliance 100. For example, water heater appliance 100 may be a dual-fuel water heater. Thus, water heater appliance 100 may be configured for heating water by combusting liquid petroleum gas, such as liquid propane (LP). In general, water heater appliance 100 may also include a combustion chamber 112 within cabinet 107 for combusting liquid propane. As such, combustion chamber 112 may include a burner assembly 110 extending therein, and combustion chamber 112 may be in thermal communication with heat exchanger 120. In general, burner assembly 110 may include a gas inlet (not labeled) and a sparker or igniter 142 for igniting fuel within combustion chamber 112. In other words, burner assembly 110 may combust fuel within combustion chamber 112, thus providing heat to heat exchanger 120 for heating water passing through water heater appliance 100. Accordingly, water may enter water heater appliance 100 and be heated by heat exchanger 120, before being distributed to other appliances or outlets for use in cooking, bathing, and the like.

In general, burner assembly 110 may be in fluid communication with a gas control valve 140 to control the flow of gas to combustion chamber 112. Burner assembly 110 may generally create combustion products, such as exhaust gases within combustion chamber 112. In general, the created combustion products may exit water heater appliance 100 to ambient atmosphere. In particular, water heater appliance 100 may include an exhaust tube 108 fluidly coupled to combustion chamber 112. For example, exhaust tube 108 may extend between an inlet 109 positioned at combustion chamber 112 and an outlet 111 along the transverse direction T. In some example embodiments, a blower assembly 144 may be fluidly coupled between combustion chamber 112 and exhaust tube 108. Blower assembly 144 may generally be configured to pull exhaust from heat exchanger 120, through exhaust tube 108, and force the exhaust out of water heater appliance 100 to ambient atmosphere. In general, water heater appliance 100 may include a controller 300 positioned within cabinet 107 and configured to operate water heater appliance 100, as will be described further below.

In the present example embodiment, an exhaust box 200 may be positioned at outlet 111 of exhaust tube 108. Exhaust box 200 may generally be a rectangular, stainless-steel box. In particular, exhaust box 200 may be fluidly coupled to exhaust tube 108 and may include exhaust outlet 104, e.g., exhaust outlet 104 may be integral to exhaust box 200 and may extend through exhaust port 103 in door 102 of water heater appliance 100. As such, the created combustion products from burner assembly 110 may exit from water heater appliance 100 to ambient atmosphere from combustion chamber 112 through exhaust tube 108, into exhaust box 200, and through exhaust outlet 104. In some example embodiments, exhaust box 200 may be excluded, e.g., exhaust tube 108 may extend from blower assembly 144 to exhaust port 103.

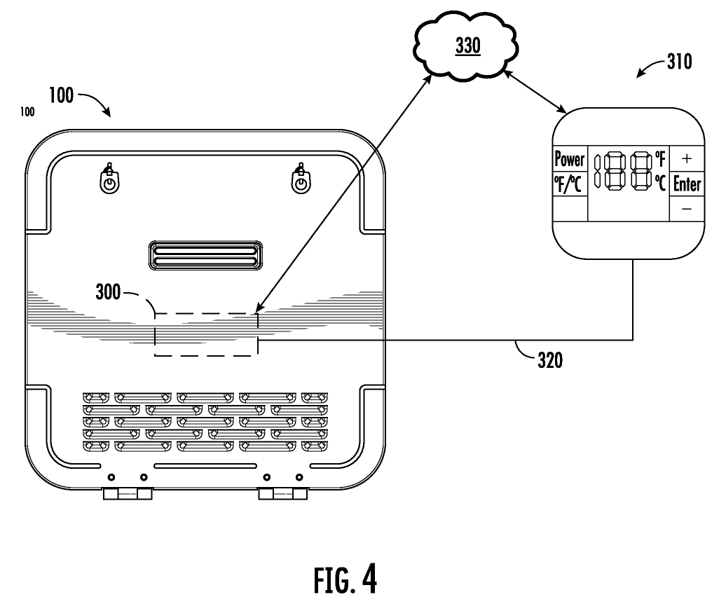

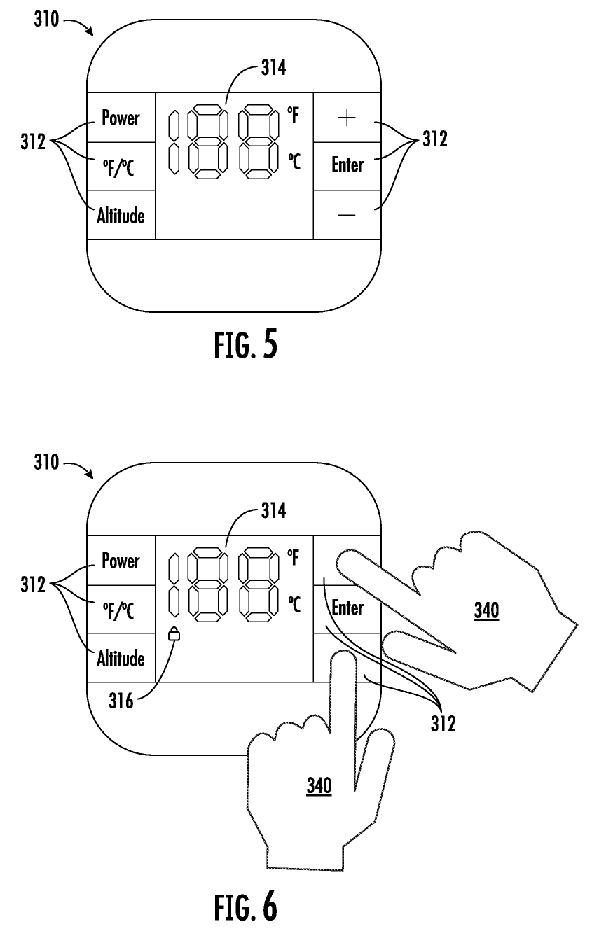

Turning now to FIGS. 4 through 6, water heater appliance 100 may generally include a control panel 310. In the present example embodiment, control panel 310 may be positioned separate from water heater appliance 100. For example, control panel 310 may be a wall-mounted user interface, or an external appliance controller, positioned within about five feet (5 ft), such as within about eight feet (8 ft), such as within about fifteen feet (15 ft) of water heater appliance 100. Control panel 310 may represent a general-purpose Input/Output (“GPIO”) device or functional block for water heater appliance 100. In some embodiments, control panel 310 may include or be in operative communication with a plurality of user input devices 312, such as one or more, or a variety, of digital, analog, electrical, mechanical, or electro-mechanical input devices including control knobs, push buttons, toggle switches, selector switches, and touch pads.

Additionally, water heater appliance 100 may include a display 314, such as a digital or analog display device generally configured to provide visual feedback regarding the operation of water heater appliance 100. For example, display 314 may be provided on control panel 310 and may include one or more status lights, screens, or visible indicators. According to example embodiments, user input devices 312 and display 314 may be integrated into a single device, e.g., including one or more of a touchscreen interface, a capacitive touch panel, a liquid crystal display (LCD), a plasma display panel (PDP), or other informational or interactive displays.

Water heater appliance 100 may further include or be in operative communication with a processing device, e.g., controller 300, that may be generally configured to facilitate appliance operation. In this regard, control panel 310, user input devices 312, and display 314 may be in signal communication with controller 300 such that controller 300 may receive user inputs from user input devices 312, may display information using display 314, and may otherwise regulate operation of water heater appliance 100. For example, signals generated by controller 300 may operate water heater appliance 100, including any or all system components, subsystems, or interconnected devices, in response to the interaction of user input devices 312 and other control commands. Control panel 310 and other components of appliance 100 may be in communication with controller 300 via, for example, one or more signal lines, e.g., wire 320, or shared communication busses. In this manner, Input/Output (“I/O”) signals may be routed between controller 300 and various operational components of water heater appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 300 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 300 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 300 may be operable to execute programming instructions or micro-control code associated with an operating cycle of water heater appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 300 as disclosed herein is capable of and may be operable to perform any methods, method steps, or portions of methods as disclosed herein. For example, in some embodiments, methods disclosed herein may be embodied in programming instructions stored in the memory and executed by controller 300.

The memory devices may also store data that can be retrieved, manipulated, created, or stored by the one or more processors or portions of controller 300. The data can include, for instance, data to facilitate performance of methods described herein. The data can be stored locally (e.g., on controller 300) in one or more databases and/or may be split up so that the data is stored in multiple locations. In addition, or alternatively, the one or more database(s) can be connected to controller 300 through any suitable network(s), e.g., network 330 (FIG. 4), such as through a high bandwidth local area network (LAN) or wide area network (WAN). In this regard, for example, controller 300 may further include a communication module or interface that may be used to communicate with one or more other component(s) of water heater appliance 100, controller 300, control panel 310, or any other suitable device, e.g., via any suitable communication lines (e.g., wire 320) or network(s) (e.g., network 330) and using any suitable communication protocol. The communication interface can include any suitable components for interfacing with one or more network(s), including for example, transmitters, receivers, ports, controllers, antennas, or other suitable components.

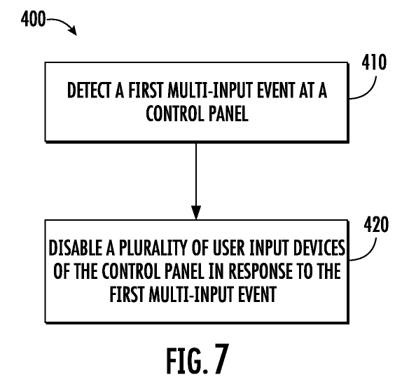

Turning now to FIG. 7, illustrated is a method 400 of operating water heater appliance 100. Method 400 may include steps performed in a particular order for purposes of illustration and discussion. Those of ordinary skill in the art, using the disclosures provided herein, will understand that the steps of any of the methods discussed herein may be adapted, rearranged, expanded, omitted, or modified in various ways without deviating from the scope of the present disclosure. Moreover, although aspects of method 400 are explained using water heater appliance 100 as an example, it should be appreciated that method 400 may be applied to the operation of any suitable appliance.

At 410, method 400 may generally include detecting a first multi-input event at control panel 310. In general, the first multi-input event may include a user input on at least two (2) user input devices of the plurality of user input devices 312. In general, the user input on at least two (2) user input devices of the plurality of user input devices 312 may include simultaneous inputs. In other example embodiments, the user input may include sequential inputs, and/or overlapping inputs. In general, the first multi-input event may occur on any suitable combination of the plurality of user input devices 312, such as two (2) user input devices of the plurality of user input devices 312 that are adjacent, or two (2) user input devices of the plurality of user input devices 312 that are spaced apart. In some example embodiments, the two (2) user input devices of the plurality of user input devices 312 may be spaced apart to reduce unintentional multi-input events. For example, FIG. 6 illustrates one example of a multi-input event, wherein a user may provide a user input, indicated by a pair of hands 340, on two (2) user input devices of the plurality of user input devices 312. The pair of hands 340 illustrated in FIG. 6 are provided by way of explanation and demonstration only, and any suitable number of hands, fingers, other bodily appendages, such as elbows or toes, or tools, such as a stylus, may be used to perform a multi-input event. For example, a user may use two (2) fingers of one (1) hand to provide a user input on two (2) user input devices of the plurality of user input devices 312.

At 420, method 400 may generally include disabling the plurality of user input devices 312 of control panel 310 in response to the first multi-input event. For example, disabling the plurality of user input devices 312 of control panel 310 may prevent settings, such as water temperature, of water heater appliance 100 from being changed while the plurality of user input devices 312 are disabled. In particular, disabling the plurality of user input devices 312 of control panel 310 may include switching controller 300 into a lock-out mode. In general, the lock-out mode of controller 300 may ignore user inputs on control panel 310, e.g., user inputs into the plurality of user input devices 312 of control panel 310 may be ignored, while the plurality of user input devices 312 of control panel 310 are disabled. As stated above, display 314 of control panel 310 may include one or more status lights, screens, or visible indicators. In particular, method 400 may include illuminating an indicator 316 on display 314 in response to disabling the plurality of user input devices 312 of control panel 310, e.g., while in the lock-out mode.

In general, the first multi-input event may include a first specified duration of the user input on at least two (2) user input devices of the plurality of user input devices 312. For example, the disabling of the plurality of user input devices 312 of control panel 310 may occur in response to the first multi-input event occurring over the first specified duration, such as over about five seconds (5s), such as over about four seconds (4s), such as over about three seconds (3s). Looking again at FIG. 6, the pair of hands 340 may engage the two (2) user input devices of the plurality of user input devices 312 for a duration of about three seconds (3s), thereby disabling of the plurality of user input devices 312 of control panel 310.

Additionally, method 400 may include detecting a second multi-input event at control panel 310 and enabling control panel 310 in response to the second multi-input event. In general, the second multi-input event may include a user input on at least two (2) user input devices of the plurality of user input devices 312. In general, the first multi-input event and the second multi-input event may include a user interacting with the same two (2) user input devices of the plurality of user input devices 312, however, other example embodiment may include a user interacting with two (2) different user input devices of the plurality of user input devices 312.

Furthermore, the second multi-input event may include a second specified duration of the user input on at least two (2) user input devices of the plurality of user input devices 312. For example, the enabling of the plurality of user input devices 312 of control panel 310 may occur in response to the second multi-input event occurring over the second specified duration, such as over about five seconds (5s), such as over about four seconds (4s), such as over about three seconds (3s). In general, the first specified duration of the first multi-input event and the second specified duration of the second multi-input event may be about equal durations, however, in other example embodiments, the first specified duration and the second specified duration may be different durations.

As may be seen from the above, a tankless water heater appliance for a recreational vehicle may advantageously include a control panel configured to selectively lock the controls. For example, a user may set a desired temperature of water produced by the water heater appliance and may then initiate a multi-input event by pressing and holding at least two (2) user input devices simultaneously on the control panel for a specified duration. In response to the multi input event, a controller of the water heater appliance may ignore inputs on the control panel. Additionally, an indicator may be illuminated to alert the user that the controls are locked.

Advantageously, locking the controls of the control panel may prevent bumps, leaning, or children from adjusting the water heater temperature from the user set temperature. When the user is done using the tankless water heater, the user may initiate another multi-input event, e.g., pressing and holding at least two (2) user input devices simultaneously on the control panel for a specified duration, to unlock the controls.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A water heater appliance for a recreational vehicle, the water heater appliance defining a vertical direction, a lateral direction, and a transverse direction, the vertical, lateral, and transverse directions mutually perpendicular, the water heater appliance comprising:
a cabinet;
a heat exchanger positioned within the cabinet;
a combustion chamber positioned within the cabinet, the combustion chamber comprising a burner assembly, the combustion chamber in thermal communication with the heat exchanger;
a controller positioned within the cabinet; and
a control panel in signal communication with the controller, the control panel comprising a plurality of user input devices,
wherein the controller is configured to:
detect a first multi-input event at the control panel, and
disable the plurality of user input devices of the control panel in response to the first multi-input event.

2. The water heater appliance of claim 1, wherein the first multi-input event comprises a user input on at least two user input devices of the plurality of user input devices.

3. The water heater appliance of claim 2, wherein the first multi-input event comprises a first specified duration of the user input on at least two user input devices of the plurality of user input devices, wherein the disabling of the plurality of user input devices of the control panel occurs in response to the first multi-input event occurring over the first specified duration.

4. The water heater appliance of claim 1, wherein the controller is further configured to:
detect a second multi-input event at the control panel, and
enable the control panel in response to the second multi-input event.

5. The water heater appliance of claim 4, wherein the second multi-input event comprises a user input on at least two user input devices of the plurality of user input devices.

6. The water heater appliance of claim 5, wherein the second multi-input event comprises a second specified duration of the user input on at least two user input devices of the plurality of user input devices, wherein the enabling of the plurality of user input devices of the control panel occurs in response to the second multi-input event occurring over the second specified duration.

7. The water heater appliance of claim 5, wherein the second multi-input event comprises the user input on the same at least two user input devices of the plurality of user input devices as the user input of the first multi-input event.

8. The water heater appliance of claim 1, wherein the control panel is positioned separate from the water heater appliance, the control panel comprising a wired connection to the controller.

9. The water heater appliance of claim 1, wherein the control panel comprises a display, wherein the controller is configured to illuminate an indicator on the display in response to disabling the plurality of user input devices of the control panel.

10. The water heater appliance of claim 1, wherein the plurality of user input devices comprises one or more of control knobs, push buttons, toggle switches, selector switches, and touch pads.

11. A method of operating a water heater appliance for a recreational vehicle, the water heater appliance comprising a cabinet, a heat exchanger positioned within the cabinet, a controller positioned within the cabinet, and a control panel in signal communication with the controller, the control panel comprising a plurality of user input devices, the method comprising:
detecting, by the controller, a first multi-input event at the control panel, and
disabling, by the controller, the plurality of user input devices of the control panel in response to the first multi-input event.

12. The method of claim 11, wherein the first multi-input event comprises receiving a user input on at least two user input devices of the plurality of user input devices.

13. The method of claim 12, wherein the first multi-input event comprises a first specified duration of the user input on at least two user input devices of the plurality of user input devices, wherein disabling the plurality of user input devices of the control panel occurs in response to the first multi-input event occurring over the first specified duration.

14. The method of claim 11, further comprising:
detecting, by the controller a second multi-input event at the control panel; and
enabling, by the controller, the plurality of user input devices of the control panel in response to the second multi-input event.

15. The method of claim 14, wherein the second multi-input event comprises receiving a user input on at least two user input devices of the plurality of user input devices.

16. The method of claim 15, wherein the second multi-input event comprises a second specified duration of the user input on at least two user input devices of the plurality of user input devices, wherein enabling the plurality of user input devices of the control panel occurs in response to the second multi-input event occurring over the second specified duration.

17. The method of claim 15, wherein the second multi-input event comprises receiving the user input on the same at least two user input devices of the plurality of user input devices as the user input of the first multi-input event.

18. The method of claim 11, wherein the control panel is positioned separate from the water heater appliance, the control panel comprising a wired connection to the controller.

19. The method of claim 11, wherein the control panel comprises a display, wherein the method further comprises illuminating, by the controller, an indicator on the display in response to disabling the plurality of user input devices of the control panel.

20. The method of claim 11, wherein the plurality of user input devices comprises one or more of control knobs, push buttons, toggle switches, selector switches, and touch pads.
